(19) United States
(12) Patent Application Publication
(10) Pub. No.: US 2026/0094333 A1
(43) Pub. Date: Apr. 2, 2026

(54) LEARNING APPARATUS, METHOD, AND PROGRAM, AND IMAGE PROCESSING APPARATUS, METHOD, AND PROGRAM

(71) Applicant: FUJIFILM Corporation, Tokyo (JP)

(72) Inventors: Keisuke YAMAKAWA, Tokyo (JP); Wataru FUKUDA, Tokyo (JP)

(73) Assignee: FUJIFILM Corporation, Tokyo (JP)

(21) Appl. No.: 19/336,089

(22) Filed: Sep. 22, 2025

(30) Foreign Application Priority Data
Sep. 27, 2024 (JP) 2024-169517

(51) Int. Cl. G06T 11/00

(52) U.S. Cl. CPC G06T 12/20; G06T 12/10; G06T 12/30; G06T 2211/441

(57) ABSTRACT

A processor acquires training data including a learning tomographic image that includes a high-attenuation substance and artifacts caused by the high-attenuation substance, and a ground truth tomographic image that does not include the high-attenuation substance and the artifacts caused by the high-attenuation substance, derives a normalized learning tomographic image and a normalized ground truth tomographic image by normalizing at least one of sharpness, contrast, or noise of the learning tomographic image and the ground truth tomographic image, and constructs a derivation model through machine learning using the normalized learning tomographic image and the normalized ground truth tomographic image, the derivation model deriving a removed tomographic image in which the high-attenuation substance and the artifacts caused by the high-attenuation substance included in a target tomographic image have been removed, in a case where the target tomographic image including the high-attenuation substance and the artifacts is input.

### CROSS REFERENCE TO RELATED APPLICATIONS

The present application claims priority from Japanese Patent Application No. 2024-169517, filed on Sep. 27, 2024, the entire disclosure of which is incorporated herein by reference.

### BACKGROUND

### Technical Field

The present disclosure relates to a learning apparatus, method, and program, and an image processing apparatus, method, and program.

### Related Art

In a computed tomography (CT) apparatus, in a case where an object having a high X-ray attenuation, such as metal, is included inside a subject, artifacts caused by a high-attenuation substance occur in a reconstructed image. Such artifacts hinder clinical diagnosis. Therefore, various methods have been proposed to remove artifacts. For example, in JP2021-157539A, a method has been proposed in which artifacts to be predicted are removed by using a removal model constructed using data that does not include artifacts, in addition to a pair of data of a cross-sectional image of a workpiece including artifacts caused by metal inside a subject and a photograph of an actual workpiece.

In the method described in JP2021-157539A, in order to construct a model for artifact removal with high accuracy, a large amount of training data with various variations is required. However, as the number of training data increases, the accuracy of artifact removal by the constructed derivation model may decrease, a need to generate a large amount of training data may arise, and the training time may become enormous. On the other hand, in a case where the number of training data is reduced, the imaging conditions and reconstruction conditions under which artifacts can be removed become limited, making it difficult to address tomographic images acquired under various conditions.

### SUMMARY OF THE INVENTION

The present disclosure has been made in view of the above-described circumstances, and an object of the present disclosure is to accurately reduce artifacts caused by a high-attenuation substance region in a tomographic image.

According to the present disclosure, there is provided a learning apparatus comprising: a processor, in which the processor is configured to: acquire training data including a learning tomographic image that includes a high-attenuation substance and artifacts caused by the high-attenuation substance, and a ground truth tomographic image that does not include the high-attenuation substance and the artifacts caused by the high-attenuation substance; derive a normalized learning tomographic image and a normalized ground truth tomographic image by normalizing at least one of sharpness, contrast, or noise of the learning tomographic image and the ground truth tomographic image; and construct a derivation model through machine learning using the normalized learning tomographic image and the normalized ground truth tomographic image, the derivation model being configured to derive a removed tomographic image in which the high-attenuation substance and the artifacts caused by the high-attenuation substance included in a target tomographic image have been removed, in a case where the target tomographic image including the high-attenuation substance and the artifacts is input.

According to the present disclosure, there is provided an image processing apparatus comprising: a processor, in which the processor is configured to: acquire a projection image including a high-attenuation substance and artifacts caused by the high-attenuation substance, the projection image being acquired by imaging a subject including the high-attenuation substance using a CT apparatus; derive a provisional tomographic image by reconstructing the projection image, derive a normalized projection image by normalizing at least one of sharpness, contrast, or noise of the provisional tomographic image, or by normalizing at least one of sharpness, contrast, or noise of the projection image, and derive a normalized tomographic image by reconstructing the normalized projection image; derive a removed tomographic image in which the high-attenuation substance and the artifacts have been removed from the normalized tomographic image by using the derivation model constructed by the learning apparatus according to the present disclosure; derive a removed projection image by inversely normalizing at least one of sharpness, contrast, or noise of the removed tomographic image and forward-projecting the inversely normalized removed tomographic image, or by forward-projecting the removed tomographic image and inversely normalizing at least one of sharpness, contrast, or noise of the forward-projected removed tomographic image; and derive a corrected projection image by replacing a region of the high-attenuation substance and the artifacts in the projection image with an image of a region corresponding to the high-attenuation substance and the artifacts in the removed projection image.

In the image processing apparatus according to the present disclosure, the processor may be configured to derive a corrected tomographic image by reconstructing the corrected projection image.

According to the present disclosure, there is provided a learning method comprising: causing a computer to: acquire training data including a learning tomographic image that includes a high-attenuation substance and artifacts caused by the high-attenuation substance, and a ground truth tomographic image that does not include the high-attenuation substance and the artifacts caused by the high-attenuation substance; derive a normalized learning tomographic image and a normalized ground truth tomographic image by normalizing at least one of sharpness, contrast, or noise of the learning tomographic image and the ground truth tomographic image; and construct a derivation model through machine learning using the normalized learning tomographic image and the normalized ground truth tomographic image, the derivation model being configured to derive a removed tomographic image in which the high-attenuation substance and the artifacts caused by the high-attenuation substance included in a target tomographic image have been removed, in a case where the target tomographic image including the high-attenuation substance and the artifacts is input.

According to the present disclosure, there is provided an image processing method comprising: causing a computer to: acquire a projection image including a high-attenuation substance and artifacts caused by the high-attenuation substance, the projection image being acquired by imaging a subject including the high-attenuation substance using a CT apparatus; derive a provisional tomographic image by reconstructing the projection image, derive a normalized projection image by normalizing at least one of sharpness, contrast, or noise of the provisional tomographic image, or by normalizing at least one of sharpness, contrast, or noise of the projection image, and derive a normalized tomographic image by reconstructing the normalized projection image; derive a removed tomographic image in which the high-attenuation substance and the artifacts have been removed from the normalized tomographic image by using the derivation model constructed by the learning apparatus according to the present disclosure; derive a removed projection image by inversely normalizing at least one of sharpness, contrast, or noise of the removed tomographic image and forward-projecting the inversely normalized removed tomographic image, or by forward-projecting the removed tomographic image and inversely normalizing at least one of sharpness, contrast, or noise of the forward-projected removed tomographic image; and derive a corrected projection image by replacing a region of the high-attenuation substance and the artifacts in the projection image with an image of a region corresponding to the high-attenuation substance and the artifacts in the removed projection image.

According to the present disclosure, there is provided a learning program for causing a computer to execute: a procedure of acquiring training data including a learning tomographic image that includes a high-attenuation substance and artifacts caused by the high-attenuation substance, and a ground truth tomographic image that does not include the high-attenuation substance and the artifacts caused by the high-attenuation substance; a procedure of deriving a normalized learning tomographic image and a normalized ground truth tomographic image by normalizing at least one of sharpness, contrast, or noise of the learning tomographic image and the ground truth tomographic image; and a procedure of constructing a derivation model through machine learning using the normalized learning tomographic image and the normalized ground truth tomographic image, the derivation model being configured to derive a removed tomographic image in which the high-attenuation substance and the artifacts caused by the high-attenuation substance included in a target tomographic image have been removed, in a case where the target tomographic image including the high-attenuation substance and the artifacts is input.

According to the present disclosure, there is provided an image processing program for causing a computer to execute: a procedure of acquiring a projection image including a high-attenuation substance and artifacts caused by the high-attenuation substance, the projection image being acquired by imaging a subject including the high-attenuation substance using a CT apparatus; a procedure of deriving a provisional tomographic image by reconstructing the projection image, deriving a normalized projection image by normalizing at least one of sharpness, contrast, or noise of the provisional tomographic image, or by normalizing at least one of sharpness, contrast, or noise of the projection image, and deriving a normalized tomographic image by reconstructing the normalized projection image; a procedure of deriving a removed tomographic image in which the high-attenuation substance and the artifacts have been removed from the normalized tomographic image by using the derivation model constructed by the learning apparatus according to the present disclosure; a procedure of deriving a removed projection image by inversely normalizing at least one of sharpness, contrast, or noise of the removed tomographic image and forward-projecting the inversely normalized removed tomographic image, or by forward-projecting the removed tomographic image and inversely normalizing at least one of sharpness, contrast, or noise of the forward-projected removed tomographic image; and a procedure of deriving a corrected projection image by replacing a region of the high-attenuation substance and the artifacts in the projection image with an image of a region corresponding to the high-attenuation substance and the artifacts in the removed projection image.

The technology of the present disclosure may be applied to a program product.

According to the present disclosure, it is possible to accurately reduce artifacts caused by a high-attenuation substance region in a tomographic image.

### BRIEF DESCRIPTION OF THE DRAWINGS

FIG. 1 is a schematic configuration diagram of a medical image capturing system comprising a learning apparatus and an image processing apparatus according to the present embodiment.

FIG. 2 is a diagram showing a hardware configuration of the learning apparatus and the image processing apparatus according to the present embodiment.

FIG. 3 is a functional configuration diagram of the learning apparatus according to the present embodiment.

FIG. 4 is a diagram showing an example of training data.

FIG. 5 is a diagram illustrating construction of a derivation model.

FIG. 6 is a functional configuration diagram of the image processing apparatus according to the present embodiment.

FIG. 7 is a diagram showing raw data acquired by imaging a head of a subject including metal using a CT apparatus.

FIG. 8 is a diagram showing a flow of processing performed by a specification unit, a correction unit, and a reconstruction unit in the present embodiment.

FIG. 9 is a diagram illustrating specification of a metal region.

FIG. 10 is a diagram illustrating forward projection of the metal region.

FIG. 11 is a diagram illustrating correction of the metal region.

FIG. 12 is a flowchart showing learning processing performed by the learning apparatus in the present embodiment.

FIG. 13 is a flowchart showing image processing performed by the image processing apparatus in the present embodiment.

FIG. 14 is a flowchart showing processing performed by the correction unit.

### DETAILED DESCRIPTION

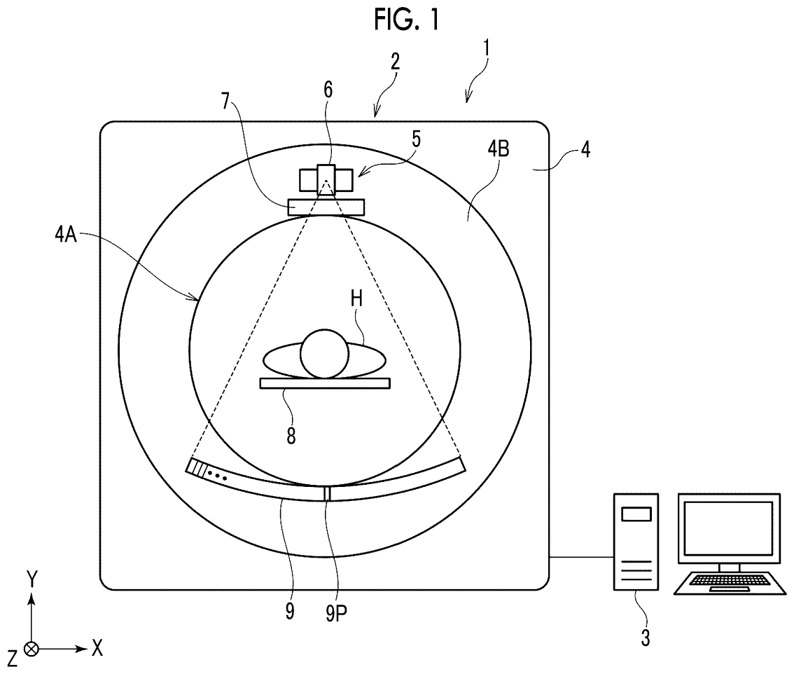

An embodiment of the present disclosure will be described in detail below with reference to the accompanying drawings. First, an example of a configuration of a medical image capturing system comprising a learning apparatus and an image processing apparatus according to the embodiment of the present disclosure will be described. FIG. 1 is a schematic configuration diagram of the medical image capturing system comprising the learning apparatus and the image processing apparatus according to the present embodiment.

A medical image capturing system 1 of the present embodiment comprises a CT apparatus 2 and a console 3, as shown in FIG. 1. The CT apparatus 2 comprises a gantry 4 and a patient table 8. In the following description, a horizontal direction in FIG. 1 is referred to as an X-axis, a vertical direction is referred to as a Y-axis, and a direction orthogonal to an XY plane is referred to as a Z-axis. The CT apparatus 2 is an example of a radiographic imaging apparatus.

The gantry 4 has an opening portion 4A, and a subject H to be imaged is disposed within the opening portion 4A while being placed on the patient table 8. The gantry 4 and the patient table 8 are configured to move relative to each other in a Z-axis direction.

Inside the gantry 4, a radiation source 5 including a radiation tube 6 and a bowtie filter 7, and a detector 9 are disposed to face each other with the subject H interposed therebetween. The bowtie filter 7 optimizes an exposure dose by increasing the dose near a center and reducing the dose in the peripheral areas, in order to suppress the exposure dose in peripheral portions. Radiation emitted from the radiation tube 6 is shaped by the bowtie filter 7 into a beam shape suitable for a size of the subject H and is then emitted to the subject H.

The detector 9 detects radiation that has been transmitted through the subject H, and generates projection data corresponding to the dose of the detected radiation. In the detector 9, a plurality of detection elements 9P are disposed in an arc shape centered on a focal point of the radiation tube 6. A direction of an arc shape in which the plurality of detection elements 9P are arranged is referred to as a channel direction.

It should be noted that, in the present embodiment, X-rays are used as an example of the radiation, but the present disclosure is not limited to this, and y-rays or the like can also be used.

The radiation source 5 and the detector 9 are attached to a rotating plate 4B provided in the gantry 4 and are rotated around the subject H by a rotation drive unit (not shown). As the radiation irradiation from the radiation source 5 and the detection of the radiation by the detector 9 are repeatedly performed in conjunction with the rotation of the radiation source 5 and the detector 9, raw data is acquired in a plurality of view units having different projection angles of the radiation onto the subject H, and the projection data is generated from the raw data. The generated projection data is output to the console 3. The projection data is derived by arranging the raw data such that the horizontal axis is the channels of the detector 9 and the vertical axis is the rotation angle of the CT apparatus 2.

The dose of radiation emitted from the radiation tube 6, a rotation speed of the gantry 4, a relative movement speed between the gantry 4 and the patient table 8, and the like are set by the console 3 based on imaging conditions input by an operator, such as a technologist.

The console 3 of the present embodiment performs control related to imaging of the subject H, generation of projection data from raw data acquired by imaging, reconstruction of a tomographic image from the projection data, settings of storage of projection data and image data of the tomographic image, and the like. In addition, the console 3 of the present embodiment also performs a process of constructing a derivation model for deriving a tomographic image in which artifacts have been removed from the tomographic image, as will be described below. The console 3 is an example of the learning apparatus and the image processing apparatus of the present disclosure.

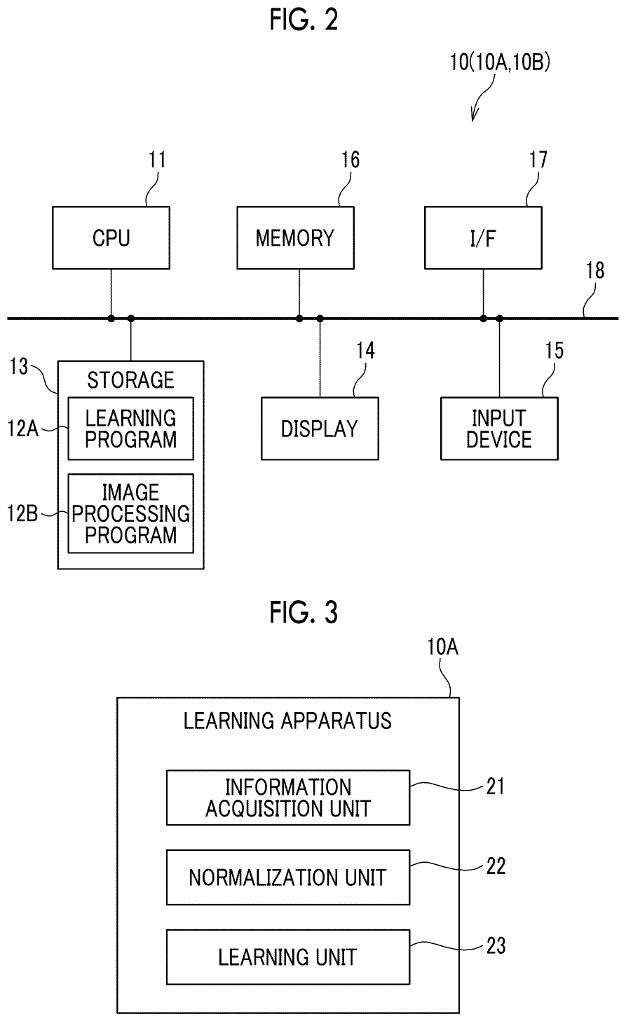

Next, the learning apparatus and the image processing apparatus according to the present embodiment will be described. First, a hardware configuration of the learning apparatus and the image processing apparatus according to the present embodiment, which are incorporated into the console 3, will be described with reference to FIG. 2. As shown in FIG. 2, a learning apparatus 10A and an image processing apparatus 10B, which are incorporated into the console 3 (and may be collectively referred to as an image processing apparatus 10), are computers, such as a workstation, a server computer, or a personal computer, and comprise a central processing unit (CPU) 11, a non-volatile storage 13, and a memory 16 as a temporary storage area.

Additionally, the image processing apparatus 10 comprises a display 14, an input device 15, and an interface (I/F) 17. The CPU 11, the storage 13, the display 14, the input device 15, the memory 16, and the I/F 17 are connected to a bus 18. The CPU 11 is an example of a processor in the present disclosure.

The storage 13 is implemented using a hard disk drive (HDD), a solid-state drive (SSD), a flash memory, or the like. A learning program 12A and an image processing program 12B installed in the image processing apparatus 10 are stored in the storage 13 as a storage medium. The CPU 11 reads the learning program 12A and the image processing program 12B from the storage 13, loads the read learning program 12A and image processing program 12B into the memory 16, and executes the loaded learning program 12A and image processing program 12B.

The display 14 is a device that displays various screens, and is, for example, a liquid crystal display or an electro luminescence (EL) display.

The input device 15 is used by the operator to input imaging conditions for imaging the subject H, instructions related to generation, display, and the like of images, various kinds of information, and the like. Examples of the input device 15 include various switches, buttons, a touch panel, a touch pen, a keyboard, a mouse, and the like. The display 14 and the input device 15 may be integrated into a touch panel display.

The I/F 17 performs communication of various kinds of information with the rotation drive unit (not shown) of the gantry 4, the radiation source 5, and the detector 9 via wired communication or wireless communication. In addition, the I/F 17 also performs communication with an image storage server (not shown) that stores training data used in a case of constructing a derivation model, as will be described below.

The learning program 12A and the image processing program 12B are stored in a storage device of a server computer connected to a network or in a network storage in a state accessible from the outside and are downloaded to and installed in a computer that constitutes the image processing apparatus 10 in response to a request. Alternatively, the learning program 12A and the image processing program 12B are distributed by being recorded on a recording medium such as a digital versatile disc (DVD) or a compact disc read-only memory (CD-ROM) and are then installed from the recording medium into the computer that constitutes the image processing apparatus 10.

Next, the learning apparatus according to the present embodiment will be described. FIG. 3 is a diagram showing a functional configuration of the learning apparatus according to the present embodiment. As shown in FIG. 3, the learning apparatus 10A comprises an information acquisition unit 21, a normalization unit 22, and a learning unit 23. Then, the CPU 11 executes the learning program 12A to function as the information acquisition unit 21, the normalization unit 22, and the learning unit 23.

The information acquisition unit 21 acquires the training data from the image storage server in response to an instruction through the input device 15. The acquired training data is stored in the storage 13. In a case where the training data is already stored in the storage 13, the information acquisition unit 21 acquires the training data from the storage 13.

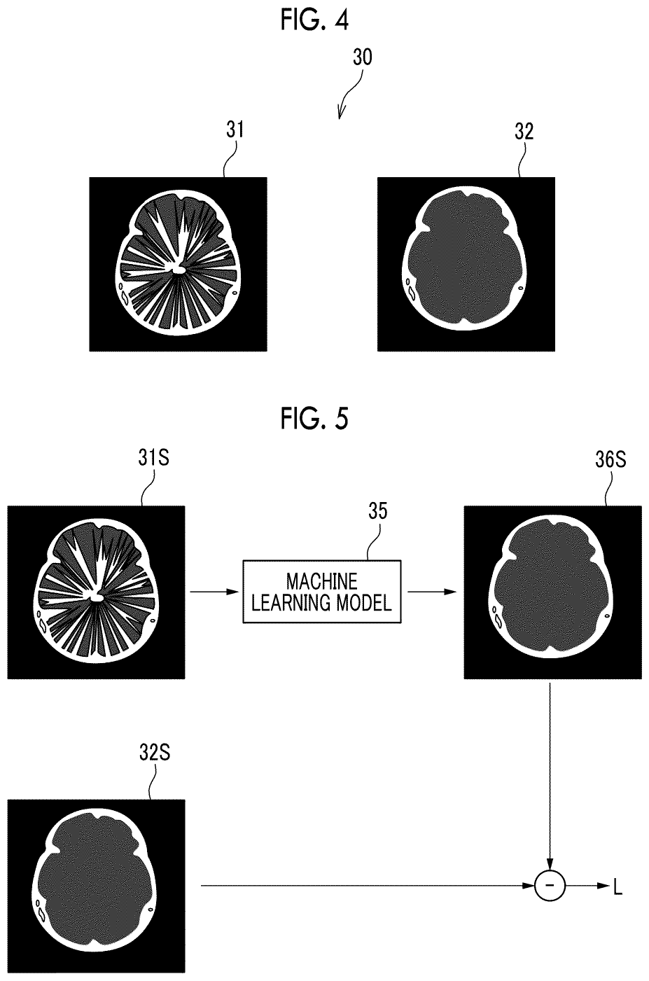

In the present embodiment, the derivation model constructed by the learning apparatus 10A is constructed to remove metal and artifacts caused by the metal included in the input tomographic image. FIG. 4 is a diagram showing an example of the training data. As shown in FIG. 4, training data 30 includes a learning tomographic image 31, which is a tomographic image of a head including metal and artifacts, and a ground truth tomographic image 32, which is a tomographic image of a head including neither metal nor artifacts. The learning tomographic image 31 and the ground truth tomographic image 32 may or may not be of the same subject.

Here, in a case where an object having a high radiation attenuation, such as metal, is included inside the subject H, artifacts caused by the metal are included in the tomographic image acquired by reconstructing the projection image represented by the projection data acquired by imaging. The learning tomographic image 31 is acquired by imaging the subject H that includes metal in the head using the CT apparatus 2. The metal is an example of a high-attenuation substance of the present disclosure.

The ground truth tomographic image 32 is acquired by imaging the subject H that does not include metal in the head using the CT apparatus 2. The ground truth tomographic image 32 does not include artifacts caused by the metal.

The normalization unit 22 normalizes the training data 30. In the present embodiment, normalization refers to normalizing at least one of sharpness, contrast, or noise of the learning tomographic image 31 and the ground truth tomographic image 32 included in the training data 30. Normalization of sharpness is performed by performing frequency processing on the learning tomographic image 31 and the ground truth tomographic image 32 to emphasize or suppress predetermined high-frequency components. For example, the modulation transfer functions (MTFs) of the learning tomographic image 31 and the ground truth tomographic image 32 need only be matched for each frequency band. Specific examples thereof include a process of approximately matching 50% MTF=0.5 (cycles/mm) and the like.

Normalization of contrast is performed by converting the pixel values (CT values) of the learning tomographic image 31 and the ground truth tomographic image 32 such that the pixel values of the learning tomographic image 31 and the ground truth tomographic image 32 fall within a predetermined range defined by a lower limit value and an upper limit value. In this case, in a case where the CT value exceeds the upper limit value, the CT value is fixed to the upper limit value. It should be noted that the contrast may also be normalized by performing a process of linearly converting the difference between the CT value of water and the CT value of a tissue, such as soft tissue and bone, within a certain range based on the CT value of water (that is, a dynamic range compression/expansion process).

Regarding normalization of noise, since the pixel values (CT values) of the learning tomographic image 31 and the ground truth tomographic image 32 are standardized, the noise in the learning tomographic image 31 and the ground truth tomographic image 32 is represented by the standard deviation (SD) of the CT values within a region of interest. In the present embodiment, noise is normalized by performing filtering using a noise removal filter or by adding noise such that the SD falls within a predetermined range (for example, SD=5 to 30 HU).

The learning unit 23 performs machine learning on a neural network using normalized training data 30S to construct the derivation model that derives a normalized removed tomographic image, in which metal and artifacts caused by the metal included in a normalized processing target tomographic image have been removed, in a case where the processing target tomographic image including the metal and the artifacts is input. FIG. 5 is a diagram illustrating the construction of the derivation model.

An example of the machine learning model for constructing the derivation model is, for example, a neural network model. Examples of the neural network model include a single-layer perceptron, a multilayer perceptron, a deep neural network, a convolutional neural network, a deep belief network, a recurrent neural network, and a probabilistic neural network.

The learning unit 23 inputs a normalized learning tomographic image 31S included in the normalized training data 30S into a machine learning model 35 to cause the machine learning model 35 to output a removed learning tomographic image 36S in which metal and artifacts caused by the metal included in the normalized learning tomographic image 31S have been removed. The learning unit 23 derives a difference between a normalized ground truth tomographic image 32S included in the training data 30S and the removed learning tomographic image 36S as a loss L. The learning unit 23 trains the machine learning model 35 based on the loss L. For example, in a case where the machine learning model 35 is a convolutional neural network, coefficients of kernels in the convolutional neural network, weights of connections in the neural network, and the like are derived so as to reduce the loss L.

The learning unit 23 repeatedly trains the machine learning model 35 using a plurality of pieces of normalized training data 30S until the loss Lis equal to or less than a predetermined threshold value. Alternatively, the learning unit 23 repeatedly trains the machine learning model a predetermined number of times. As a result, a derivation model 38 that derives a normalized removed tomographic image in which a metal region and artifacts included in a normalized processing target tomographic image, which includes metal and artifacts caused by the metal, have been removed, in a case where the processing target tomographic image is input is constructed. The constructed derivation model 38 is stored in the storage 13.

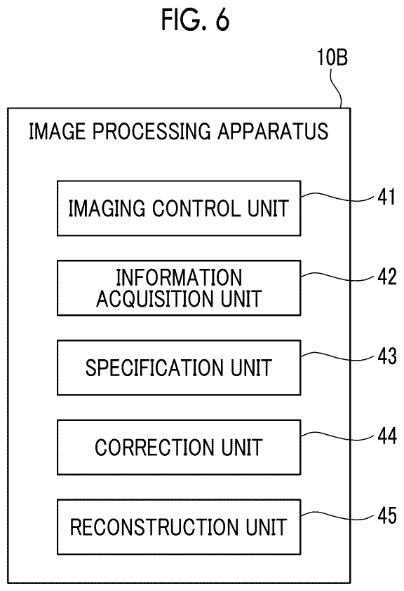

Next, the image processing apparatus according to the present embodiment will be described. FIG. 6 is a diagram showing the functional configuration of the image processing apparatus according to the present embodiment. As shown in FIG. 6, the image processing apparatus 10B comprises an imaging control unit 41, an information acquisition unit 42, a specification unit 43, a correction unit 44, and a reconstruction unit 45. Then, the CPU 11 executes the image processing program 12B to function as the imaging control unit 41, the information acquisition unit 42, the specification unit 43, the correction unit 44, and the reconstruction unit 45.

The imaging control unit 41 controls each unit of the CT apparatus 2 to perform imaging of the subject H in response to an instruction through the input device 15. In the present embodiment, it is assumed that the head of the subject His imaged. Additionally, it is assumed for the purpose of description that the head includes metal. The metal is an example of a high-attenuation substance of the present disclosure.

The information acquisition unit 42 acquires the projection data acquired by imaging the subject H from the CT apparatus 2. The image represented by the projection data is a projection image.

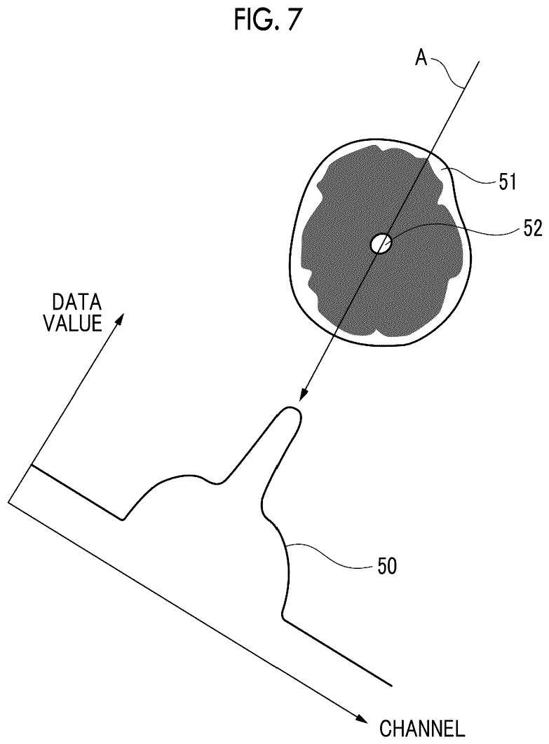

FIG. 7 is a diagram showing the raw data acquired by imaging the head of the subject H including metal using the CT apparatus 2. In FIG. 7, raw data 50 in a case where a head 51 is irradiated with radiation in a direction of an arrow A is shown. In the raw data 50 shown in FIG. 7, a horizontal axis represents a channel direction of the detector 9, and a vertical axis represents a data value. In the raw data 50, the data value is small in a channel (that is, the detection element 9P) that has detected radiation which is not transmitted through the head 51, the data value is large in a channel that has detected radiation which is transmitted through the head 51, and the data value in a channel that has detected radiation which is transmitted through metal 52 located inside the head 51 exhibits a peak. The projection data is obtained by arranging such raw data with the horizontal axis representing the channel direction of the detector 9 and the vertical axis representing the rotation angle.

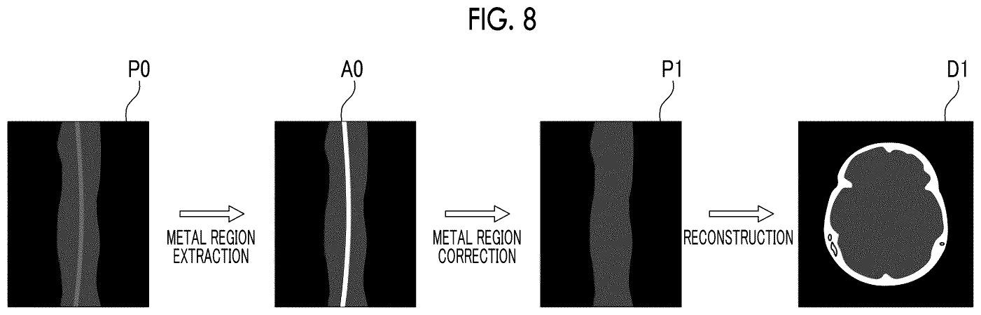

FIG. 8 is a diagram showing a flow of processing performed by the specification unit 43, the correction unit 44, and the reconstruction unit 45 in the present embodiment. As shown in FIG. 8, first, a metal region A0 is extracted from a projection image P0 represented by the projection data. Next, the metal region A0 in the projection image P0 is corrected, and a corrected projection image P1 is derived. Further, the corrected projection image P1 is reconstructed, and a corrected tomographic image D1 is derived. Hereinafter, individual processes performed by the specification unit 43, the correction unit 44, and the reconstruction unit 45 will be described.

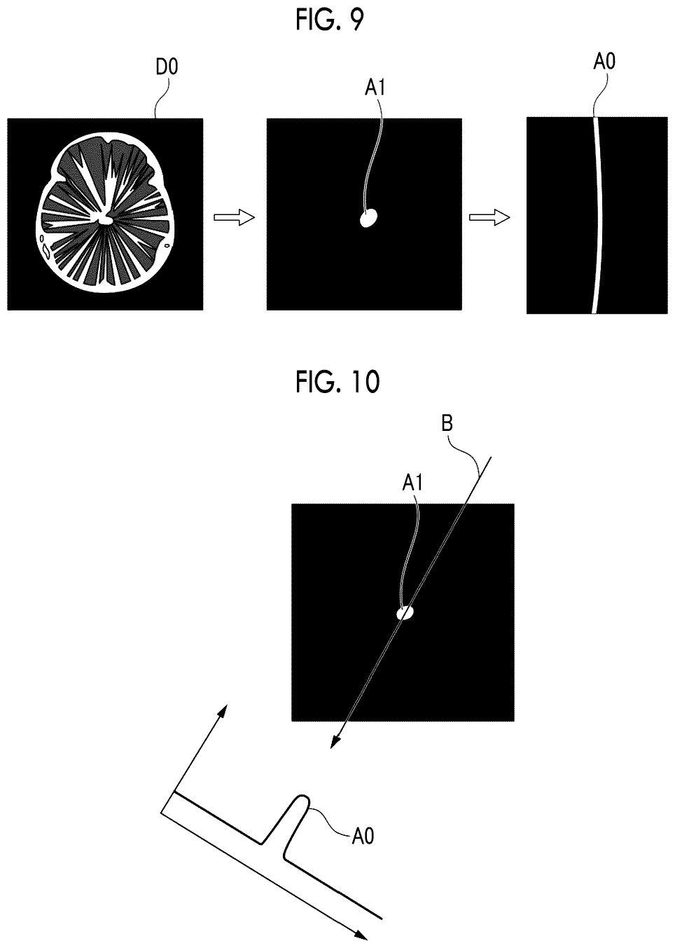

The specification unit 43 specifies the metal region in the projection image. FIG. 9 is a diagram illustrating the specification of the metal region. The specification unit 43 first derives a provisional tomographic image D0 through reconstruction of the projection image P0 by the reconstruction unit 45. Here, the provisional tomographic image D0 includes the metal region and artifacts caused by an influence of the metal. The specification unit 43 removes the artifacts from the provisional tomographic image D0. For example, the specification unit 43 removes the artifacts from the provisional tomographic image D0 by using a removal model constructed to remove artifacts from the tomographic image. The removal model used by the specification unit 43 is constructed to remove only the artifacts from the provisional tomographic image D0, unlike the derivation model 38 constructed by the learning apparatus 10A according to the present embodiment. In addition, the input provisional tomographic image D0 need not be normalized.

The specification unit 43 specifies a metal region A1 in the provisional tomographic image from which the artifacts have been removed. Since the metal region A1 is a high-brightness region in the provisional tomographic image from which the artifacts have been removed, the specification unit 43 extracts the metal region A1 by using an extraction model constructed to extract such a high-brightness region. Then, as shown in FIG. 10, the specification unit 43 specifies the metal region A0 in the projection image P0 by forward-projecting the metal region A1 in a direction of an arrow B.

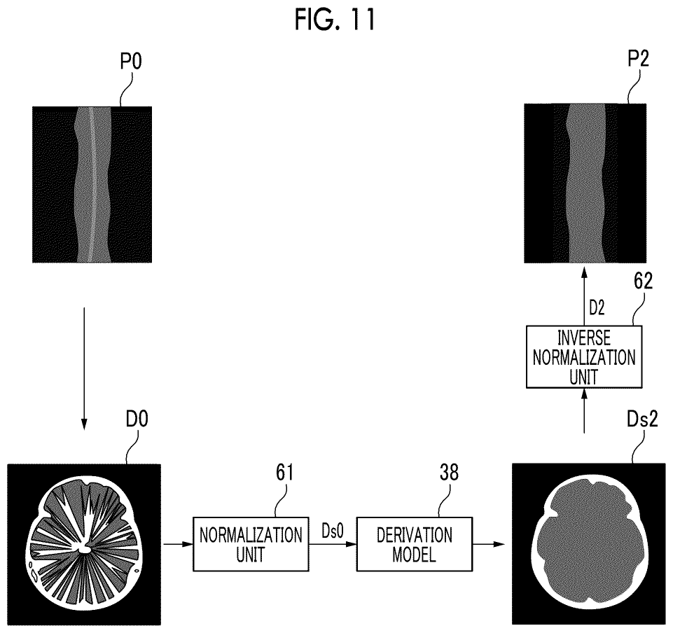

The correction unit 44 derives a corrected projection image P1 by correcting the projection image P0. FIG. 11 is a diagram illustrating the correction of the metal region. As shown in FIG. 11, the correction unit 44 includes a normalization unit 61 and an inverse normalization unit 62. The correction unit 44 derives the provisional tomographic image D0 through reconstruction of the projection image P0 by the reconstruction unit 45. The provisional tomographic image D0 derived by the specification unit 43 may be used. The provisional tomographic image D0 includes metal and artifacts caused by the influence of the metal. The normalization unit 61 of the correction unit 44 normalizes the provisional tomographic image D0. In this case, the normalization unit 61 normalizes at least one of the sharpness, contrast, or noise of the provisional tomographic image D0, in the same manner as in the normalization performed by the normalization unit 22 of the learning apparatus 10A mentioned above. As a result, a normalized tomographic image Ds0 is derived.

It should be noted that, in a case where the tube voltage used for imaging the subject H is different from the tube voltage used for acquiring the learning tomographic image 31, the contrast differs between the provisional tomographic image D0 and the learning tomographic image 31, even in a case where the provisional tomographic image D0 and the learning tomographic image 31 are of the same site of the same subject. Therefore, in a case where the contrast normalization process performed by the normalization unit 61 involves dynamic range compression/expansion, and the tube voltage used for imaging the subject H is different from the tube voltage used for acquiring the learning tomographic image 31, normalization is performed after adjusting the pixel values of the provisional tomographic image D0 to the pixel values corresponding to those under the tube voltage used during learning by multiplying the pixel values of the provisional tomographic image D0 by a coefficient according to the difference in tube voltage.

The normalization unit 61 may normalize the projection image P0 instead of the provisional tomographic image D0. In this case, the correction unit 44 derives the normalized tomographic image Ds0 through reconstruction of the normalized projection image P0 by the reconstruction unit 45.

The correction unit 44 inputs the normalized tomographic image Ds0 into the derivation model 38 to derive a removed tomographic image Ds2 in which metal and artifacts caused by the metal included in the normalized tomographic image Ds0 have been removed.

In the present embodiment, since the removed tomographic image Ds2 is derived from the normalized tomographic image Ds0, at least one of the sharpness, contrast, or noise is normalized. Therefore, in the present embodiment, the inverse normalization unit 62 of the correction unit 44 derives an inverse-normalized removed tomographic image D2 by inversely normalizing the removed tomographic image Ds2. Inverse normalization refers to a process of matching at least one of the sharpness, contrast, or noise of the removed tomographic image Ds2 with at least one of the sharpness, contrast, or noise of the projection image P0 or the provisional tomographic image D0.

For example, inverse normalization of sharpness need only be performed by performing frequency processing on the removed tomographic image Ds2 to suppress or emphasize predetermined high-frequency components so that the spatial frequency of the removed tomographic image Ds2 matches the spatial frequency of the projection image P0 or the provisional tomographic image D0. Inverse normalization of contrast need only be performed by converting the pixel values (CT values) of the removed tomographic image Ds2 such that the pixel values of the removed tomographic image Ds2 fall within a range defined by a lower limit value and an upper limit value of the projection image P0 or the provisional tomographic image D0. It should be noted that the inverse normalization process may also be performed by performing the dynamic range compression/expansion process on the removed tomographic image Ds2. Inverse normalization of noise need only be performed by performing filtering using a noise removal filter or by adding noise such that the SD of the removed tomographic image Ds2 falls within the same range as the SD of the projection image P0 or the provisional tomographic image D0. Through such an inverse normalization process, the inverse normalization unit 62 derives the inverse-normalized removed tomographic image D2 from the removed tomographic image Ds2.

The correction unit 44 derives a removed projection image P2 by forward-projecting the inverse-normalized removed tomographic image D2. Further, the correction unit 44 corrects the metal region A0 of the projection image P0 by replacing the metal region A0 in the projection image P0 with an image of a region corresponding to the metal region A0 in the removed projection image P2, and derives the corrected projection image P1.

The reconstruction unit 45 derives the corrected tomographic image D1 by reconstructing the corrected projection images P1 at a plurality of projection angles (refer to FIG. 8).

It should be noted that the removed projection image P2 may be derived by forward-projecting the removed tomographic image Ds2 and inversely normalizing the forward-projected removed tomographic image Ds2, instead of inversely normalizing the removed tomographic image Ds2.

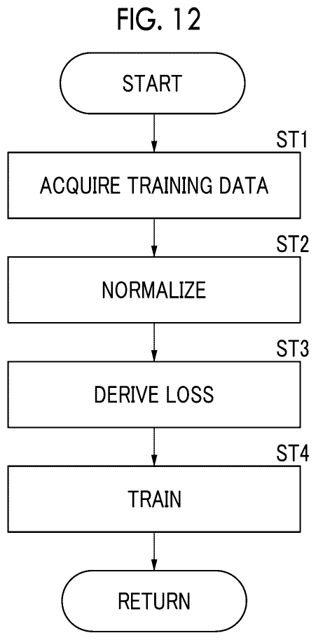

Next, processing performed in the present embodiment will be described. FIG. 12 is a flowchart showing learning processing performed by the learning apparatus 10A in the present embodiment. It is assumed that the training data 30 is acquired from the image storage server and stored in the storage 13. First, the information acquisition unit 21 acquires the training data 30 stored in the storage 13 (step ST1). Next, the normalization unit 22 normalizes the learning tomographic image 31 and the ground truth tomographic image 32 included in the training data 30 to derive the normalized learning tomographic image 31S and the normalized ground truth tomographic image 32S (step ST2).

The learning unit 23 inputs the normalized learning tomographic image 31S into the machine learning model 35 to cause the machine learning model 35 to output the removed learning tomographic image 36S in which the metal region and the artifacts caused by the metal included in the normalized learning tomographic image 31S have been removed, and derives the loss L with the normalized ground truth tomographic image 32S (step ST3). Then, the learning unit 23 trains the machine learning model 35 such that the loss L is equal to or less than a predetermined threshold value (step ST4).

The learning unit 23 returns to the processing of step ST1, acquires the next training data 30S from the storage 13, and repeats the processing of steps ST1 to ST4. As a result, the derivation model 38 is constructed.

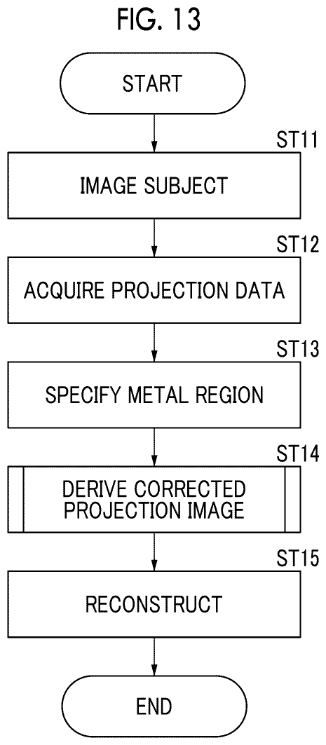

Next, image processing performed in the present embodiment will be described. FIG. 13 is a flowchart showing image processing performed by the image processing apparatus in the present embodiment. First, the imaging control unit 41 images the subject H using the CT apparatus 2 in response to an instruction from the operator (step ST11), and the information acquisition unit 42 acquires the projection data (step ST12). The specification unit 43 specifies the metal region A0 in the projection image P0 represented by the projection data (step ST13). The correction unit 44 corrects the projection image P0 to derive the corrected projection image P1 (step ST14).

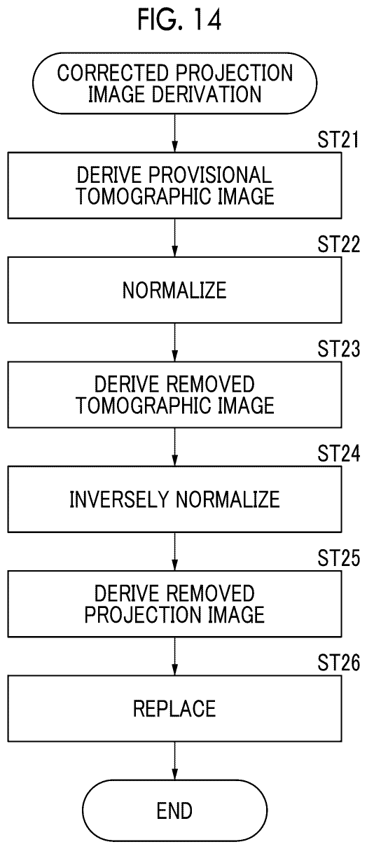

FIG. 14 is a flowchart showing processing performed by the correction unit 44. The correction unit 44 derives the provisional tomographic image D0 through reconstruction of the projection image P0 by the reconstruction unit 45 (step ST21). The normalization unit 61 of the correction unit 44 normalizes the provisional tomographic image D0 to derive the normalized tomographic image Ds0 (step ST22). The correction unit 44 inputs the normalized tomographic image Ds0 into the derivation model 38 to derive the removed tomographic image Ds2 in which the metal region and the artifacts caused by the metal region included in the normalized tomographic image Ds0 have been removed (step ST23).

The inverse normalization unit 62 of the correction unit 44 derives the inverse-normalized removed tomographic image D2 by inversely normalizing the removed tomographic image Ds2 (step ST24). The correction unit 44 derives the removed projection image P2 by forward-projecting the inverse-normalized removed tomographic image D2 (step ST25). Further, the correction unit 44 corrects the metal region A0 of the projection image P0 by replacing the metal region A0 in the projection image P0 with the image of the region corresponding to the metal region A0 in the removed projection image P2, and derives the corrected projection image P1 (replacement; step ST26).

The description returns to FIG. 13. The reconstruction unit 45 derives the corrected tomographic image D1 by reconstructing the corrected projection image P1 (step ST15), and the processing ends.

As described above, in the learning apparatus 10A according to the present embodiment, the learning tomographic image 31 and the ground truth tomographic image 32 are normalized, and through machine learning using the normalized learning tomographic image 31S and the normalized ground truth tomographic image 32S, the derivation model 38 that derives the removed tomographic image in which metal and artifacts caused by the metal included in the target tomographic image have been removed, in a case where the target tomographic image including the metal and the artifacts is input, is constructed. Accordingly, the variations in the training data can be reduced, and as a result, it is possible to prevent a decrease in the accuracy of artifact removal by the derivation model and to shorten the training time.

In addition, in the image processing apparatus 10B according to the present embodiment, the provisional tomographic image derived by reconstructing the projection image is normalized, the removed tomographic image in which metal and artifacts caused by the metal have been removed from the normalized provisional tomographic image is derived using the derivation model 38, and the removed projection image is derived by inversely normalizing the removed tomographic image and forward-projecting the inversely normalized removed tomographic image. Further, the corrected projection image is derived by replacing the metal region in the projection image with the image of the corresponding region in the removed projection image, and the corrected tomographic image is derived by reconstructing the corrected projection image. Therefore, it is possible to derive the corrected tomographic image in which metal and artifacts caused by the metal have been removed. Additionally, since the removed projection image is derived by inversely normalizing the removed tomographic image and forward-projecting the inversely normalized removed tomographic image, at least one of the sharpness, contrast, or noise can be matched between the removed projection image and the projection image. Therefore, in a case where the metal region in the projection image is replaced with the image of the corresponding region in the removed projection image, no difference in at least one of the sharpness, contrast, or noise occurs between the replaced region and a region other than the replaced region in the projection image. Accordingly, a high-quality corrected tomographic image can be acquired.

In the above-described embodiment, the derivation model 38 is constructed by applying the learning apparatus 10A to the console 3, but the present disclosure is not limited to this. The console 3 may construct the derivation model 38 by applying the learning apparatus 10A to another computer or the like. In this case, the constructed derivation model 38 is transmitted to the console 3 and stored, and is used for the process of correcting metal and artifacts.

In the present embodiment, each process is executed by any computer. Additionally, any computer may execute these processes by means of a processor as hardware, a program as software, or a combination thereof. In that case, the processor is configured to execute various types of processing in the present embodiment in cooperation with the program and can function as each unit or each means in the present embodiment. In addition, the execution order of the process by the processor is not limited to the order described above and may be changed as appropriate. Any computer may be a general-purpose computer, a computer for a specific application, a workstation, or another system capable of executing each process.

The processor may be configured using one or more pieces of hardware, and the type of hardware is not limited. For example, the processor may be configured using hardware, such as a central processing unit (CPU), a micro processing unit (MPU), a programmable logic device, such as a field programmable gate array (FPGA), a dedicated circuit that is used to execute specific processing, such as an application-specific integrated circuit (ASIC), a graphic processing unit (GPU), or a neural processing unit (NPU). In addition, the type of hardware may be a combination of different types of hardware. In a case where a plurality of pieces of hardware are configured to execute one or more processes of a certain processor, the plurality of pieces of hardware may be present in devices physically separated from each other or may be present in the same device. Additionally, in any of the embodiments, the order of each process by the processor is not limited to the order described above and may be changed as appropriate. The hardware is configured using an electrical circuit (circuitry) in which circuit elements, such as semiconductor elements, are combined, or the like.

Further, the program may be software, such as firmware or a microcode. In addition, the program may be, for example, a program module group, and each function thereof may be implemented by a processor configured to execute the corresponding function. The program may be a program code or a plurality of code segments stored in one or more non-transitory computer-readable media (for example, storage media, other storages, or the like). The program may be distributed and stored across a plurality of non-transitory computer-readable media that are present in devices physically separated from each other. The program code or code segments may represent any combination of procedures, functions, subprograms, routines, subroutines, modules, software packages, classes, or commands, data structures, or program statements. The program code or the code segment may be connected to another code segment or a hardware circuit by transmitting and receiving information, data, an argument, a parameter, or contents of a memory.

Additionally, in the above-described embodiment, an aspect has been described in which the learning program 12A and the image processing program 12B are stored (installed) in advance in the storage 13, but the present disclosure is not limited to this aspect. The learning program 12A and the image processing program 12B may be provided in a form recorded on a recording medium, such as a compact disc read-only memory (CD-ROM), a digital versatile disc read-only memory (DVD-ROM), and a universal serial bus (USB) memory. Further, the learning program 12A and the image processing program 12B may be downloaded from an external device via the network.

The technology of the present disclosure extends to all kinds of program products. The program product includes all forms of products for providing a program. For example, the program product includes a program provided through a network such as the Internet, a non-transitory computer-readable recording medium, such as a CD-ROM, a DVD, and a USB memory in which the program is stored, and the like.

What is claimed is:

1. A learning apparatus comprising:
a processor,
wherein the processor is configured to:
acquire training data including a learning tomographic image that includes a high-attenuation substance and artifacts caused by the high-attenuation substance, and a ground truth tomographic image that does not include the high-attenuation substance and the artifacts caused by the high-attenuation substance;
derive a normalized learning tomographic image and a normalized ground truth tomographic image by normalizing at least one of sharpness, contrast, or noise of the learning tomographic image and the ground truth tomographic image; and
construct a derivation model through machine learning using the normalized learning tomographic image and the normalized ground truth tomographic image, the derivation model being configured to derive a removed tomographic image in which the high-attenuation substance and the artifacts caused by the high-attenuation substance included in a target tomographic image have been removed, in a case where the target tomographic image including the high-attenuation substance and the artifacts is input.

2. An image processing apparatus comprising:
a processor,
wherein the processor is configured to:
acquire a projection image including a high-attenuation substance and artifacts caused by the high-attenuation substance, the projection image being acquired by imaging a subject including the high-attenuation substance using a CT apparatus;
derive a provisional tomographic image by reconstructing the projection image, derive a normalized projection image by normalizing at least one of sharpness, contrast, or noise of the provisional tomographic image, or by normalizing at least one of sharpness, contrast, or noise of the projection image, and derive a normalized tomographic image by reconstructing the normalized projection image;
derive a removed tomographic image in which the high-attenuation substance and the artifacts have been removed from the normalized tomographic image by using the derivation model constructed by the learning apparatus according to claim 1;
derive a removed projection image by inversely normalizing at least one of sharpness, contrast, or noise of the removed tomographic image and forward-projecting the inversely normalized removed tomographic image, or by forward-projecting the removed tomographic image and inversely normalizing at least one of sharpness, contrast, or noise of the forward-projected removed tomographic image; and
derive a corrected projection image by replacing a region of the high-attenuation substance and the artifacts in the projection image with an image of a region corresponding to the high-attenuation substance and the artifacts in the removed projection image.

3. The image processing apparatus according to claim 2,
wherein the processor is configured to derive a corrected tomographic image by reconstructing the corrected projection image.

4. A learning method comprising:
causing a computer to:
acquire training data including a learning tomographic image that includes a high-attenuation substance and artifacts caused by the high-attenuation substance, and a ground truth tomographic image that does not include the high-attenuation substance and the artifacts caused by the high-attenuation substance;
derive a normalized learning tomographic image and a normalized ground truth tomographic image by normalizing at least one of sharpness, contrast, or noise of the learning tomographic image and the ground truth tomographic image; and
construct a derivation model through machine learning using the normalized learning tomographic image and the normalized ground truth tomographic image, the derivation model being configured to derive a removed tomographic image in which the high-attenuation substance and the artifacts caused by the high-attenuation substance included in a target tomographic image have been removed, in a case where the target tomographic image including the high-attenuation substance and the artifacts is input.

5. An image processing method comprising:
causing a computer to:
acquire a projection image including a high-attenuation substance and artifacts caused by the high-attenuation substance, the projection image being acquired by imaging a subject including the high-attenuation substance using a CT apparatus;
derive a provisional tomographic image by reconstructing the projection image, derive a normalized projection image by normalizing at least one of sharpness, contrast, or noise of the provisional tomographic image, or by normalizing at least one of sharpness, contrast, or noise of the projection image, and derive a normalized tomographic image by reconstructing the normalized projection image;
derive a removed tomographic image in which the high-attenuation substance and the artifacts have been removed from the normalized tomographic image by using the derivation model constructed by the learning apparatus according to claim 1;
derive a removed projection image by inversely normalizing at least one of sharpness, contrast, or noise of the removed tomographic image and forward-projecting the inversely normalized removed tomographic image, or by forward-projecting the removed tomographic image and inversely normalizing at least one of sharpness, contrast, or noise of the forward-projected removed tomographic image; and
derive a corrected projection image by replacing a region of the high-attenuation substance and the artifacts in the projection image with an image of a region corresponding to the high-attenuation substance and the artifacts in the removed projection image.

6. A non-transitory computer-readable storage medium that stores a learning program for causing a computer to execute:
a procedure of acquiring training data including a learning tomographic image that includes a high-attenuation substance and artifacts caused by the high-attenuation substance, and a ground truth tomographic image that does not include the high-attenuation substance and the artifacts caused by the high-attenuation substance;
a procedure of deriving a normalized learning tomographic image and a normalized ground truth tomographic image by normalizing at least one of sharpness, contrast, or noise of the learning tomographic image and the ground truth tomographic image; and
a procedure of constructing a derivation model through machine learning using the normalized learning tomographic image and the normalized ground truth tomographic image, the derivation model being configured to derive a removed tomographic image in which the high-attenuation substance and the artifacts caused by the high-attenuation substance included in a target tomographic image have been removed, in a case where the target tomographic image including the high-attenuation substance and the artifacts is input.

7. A non-transitory computer-readable storage medium that stores an image processing program for causing a computer to execute:
a procedure of acquiring a projection image including a high-attenuation substance and artifacts caused by the high-attenuation substance, the projection image being acquired by imaging a subject including the high-attenuation substance using a CT apparatus;
a procedure of deriving a provisional tomographic image by reconstructing the projection image, deriving a normalized projection image by normalizing at least one of sharpness, contrast, or noise of the provisional tomographic image, or by normalizing at least one of sharpness, contrast, or noise of the projection image, and deriving a normalized tomographic image by reconstructing the normalized projection image;
a procedure of deriving a removed tomographic image in which the high-attenuation substance and the artifacts have been removed from the normalized tomographic image by using the derivation model constructed by the learning apparatus according to claim 1;
a procedure of deriving a removed projection image by inversely normalizing at least one of sharpness, contrast, or noise of the removed tomographic image and forward-projecting the inversely normalized removed tomographic image, or by forward-projecting the removed tomographic image and inversely normalizing at least one of sharpness, contrast, or noise of the forward-projected removed tomographic image; and
a procedure of deriving a corrected projection image by replacing a region of the high-attenuation substance and the artifacts in the projection image with an image of a region corresponding to the high-attenuation substance and the artifacts in the removed projection image.
